(19) United States
(12) Patent Application Publication
(10) Pub. No.: US 2015/0017823 A1
(43) Pub. Date: Jan. 15, 2015

(54) CONNECTOR

(71) Applicants: Molex Incorporated, Lisle, IL (US); Murakami Corporation, Shizuoka (JP)

(72) Inventors: Takayuki Hori, Yamato (JP); Masahiro Motomiya, Shizuoka (JP)

(73) Assignees: Molex Incorporated, Lisle, IL (US); Murakami Corporation, Shizuoka (JP)

(21) Appl. No.: 14/373,101

(22) PCT Filed: Jan. 17, 2013
(86) PCT No.: PCT/US2013/021931

§ 371 Date: Jul. 18, 2014

(30) Foreign Application Priority Data
Jan. 18, 2012 (JP) 2012-008521

(51) Int. Cl. H01R 4/66

(52) U.S. Cl. CPC H01R 4/66
USPC 439/101

(57) ABSTRACT

In the connector disclosed herein, a shunting member is arranged between the case and the cover member. The shunting member has a first contact piece elastically deformed by contact with a terminal inserted into a first terminal hole in the case, and a second contact piece elastically deformed by contact with a terminal inserted into a second terminal hole.

### REFERENCE TO RELATED APPLICATIONS

The Present Disclosure claims priority to prior-filed Japanese Patent Application No. 2012-008521, entitled “Connector,” filed on 18 Jan. 2012 with the Japanese Patent Office. The content of the aforementioned Patent Application is incorporated in its entirety herein.

### BACKGROUND OF THE PRESENT DISCLOSURE

The Present Disclosure relates, generally, to a connector and, more specifically, to a technique for shunting two terminals.

A connector disclosed in Japanese Patent Application No. 2007-209454 has a shunting member for shunting two terminals. This shunting member is a metal plate bent into a U-shape, and has a main body portion fixed to a case and a pair of contact pieces elastically deformed in the thickness direction of the plate facing the main body portion. The content of the aforementioned Patent Application is incorporated in its entirety herein.

However, it is difficult to reduce the size of a connector using conventional techniques because there has to be a relatively large gap between the main body portion and the contact pieces in order to provide enough force to bring the contact pieces into contact with a terminal.

### SUMMARY OF THE PRESENT DISCLOSURE

In light of this situation, one purpose of the Present Disclosure is to provide a connector with a shunting member for shunting two terminals which can be reduced in size. In order to solve the aforementioned disadvantages, the Present Disclosure discloses a connector comprising a case having a plurality of terminal holes formed to insert terminals in one direction from one side, a cover member attached to the other side of the case in the one direction and having a plurality of terminal holes formed to correspond to the plurality of terminal holes, and a shunting member arranged between the case and the cover member. The shunting member has a first contact piece elastically deformed by contact with a terminal inserted into a first terminal hole in the case, and a second contact piece elastically deformed by contact with a terminal inserted into a second terminal hole. The shunting member is a metal plate. The first contact piece and the second piece are elastically deformed towards each other on the inside.

Because the two contact pieces are elastically deformed towards each other on the inside, the two contact pieces can obtain a large elastic restoring force from a small amount of elastic deformation. As a result, a more compact connector with a shunting member can be obtained.

In an aspect of the Present Disclosure, the shunting member has an intermediate piece engaging the cover member between the first contact piece and the second contact piece. This can suppress the effects of the elastic deformation of one contact piece on the other contact piece.

In another aspect of the Present Disclosure, the shunting member has a fixing portion inserted into the cover member in the same direction as the terminal insertion direction. This can suppress the displacement of the shunting member when a terminal makes contact with the contact pieces.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1A is a perspective view of a connector according to the Present Disclosure;

FIG. 1B is a disassembled perspective view of the connector of FIG. 1A;

FIG. 2A is a perspective view of the first connector included in the connector of FIG. 1A;

FIG. 2B is a disassembled perspective view of the first connector of FIG. 2A;

FIG. 3 is a perspective view of the cover member and the shunting member included in the first connector of FIG. 2A;

FIG. 4 is a side view of the case included in the first connector of FIG. 2A;

FIG. 5 is a side view of the first connector of FIG. 2A;

FIG. 6A is a top view of the shunting member of FIG. 3;

FIG. 6B is a side view of the shunting member of FIG. 3;

FIG. 6C is a bottom view of the shunting member of FIG. 3; and

FIG. 7 is a cross-sectional view of the first connector of FIG. 2A.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

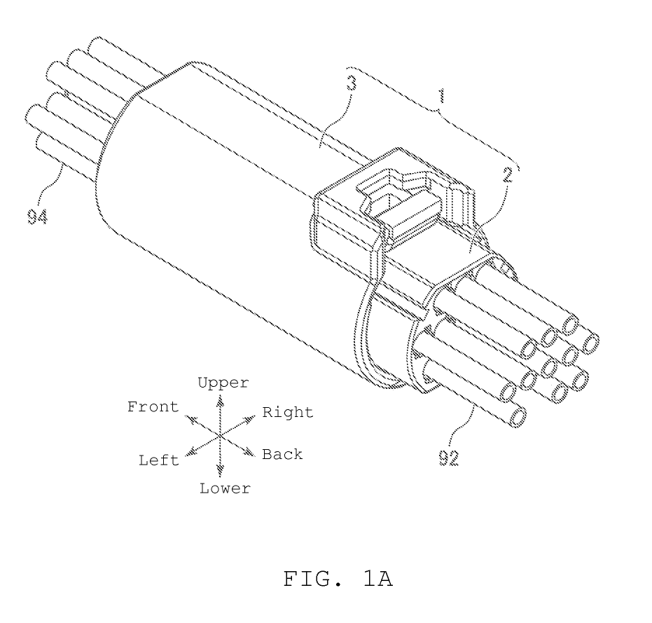

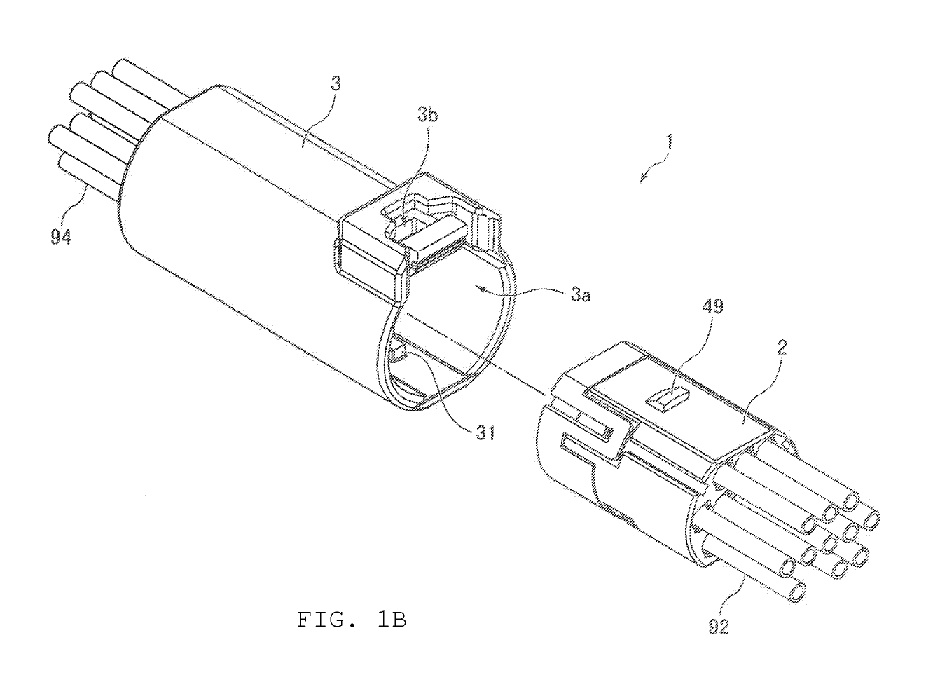

As shown in FIGS. 1A-B, the connector 1 has a substantially columnar first connector 2 connected to a plurality of cables 92, and a substantially cylindrical second connector 3 connected to a plurality of cables 94. The second connector 3 has an insertion hole 3a open to the rear for insertion of the first connector 2. An engaging hole 3b is formed in the upper portion of the side wall of the second connector 3 for engaging an engaging piece 49 on the first connector 2. There is also a rail portion 31 provided on the bottom portion of the inner side face of the second connector 3 and extending in the longitudinal direction.

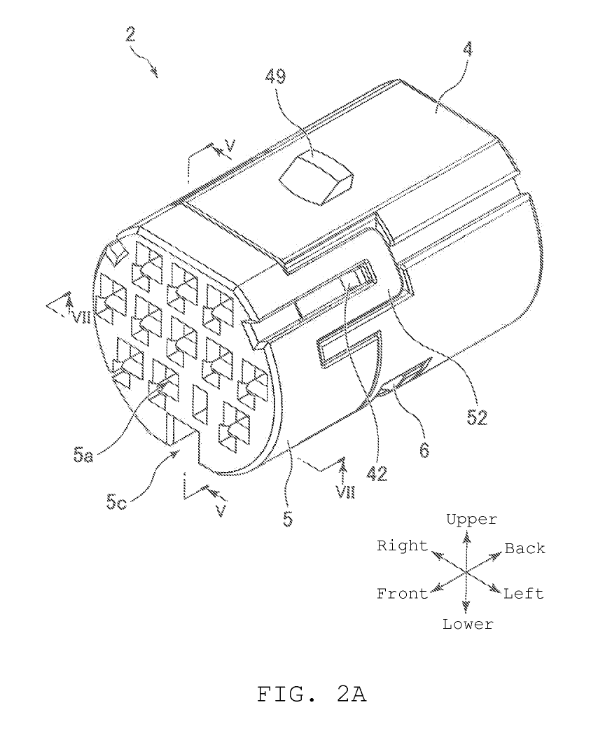

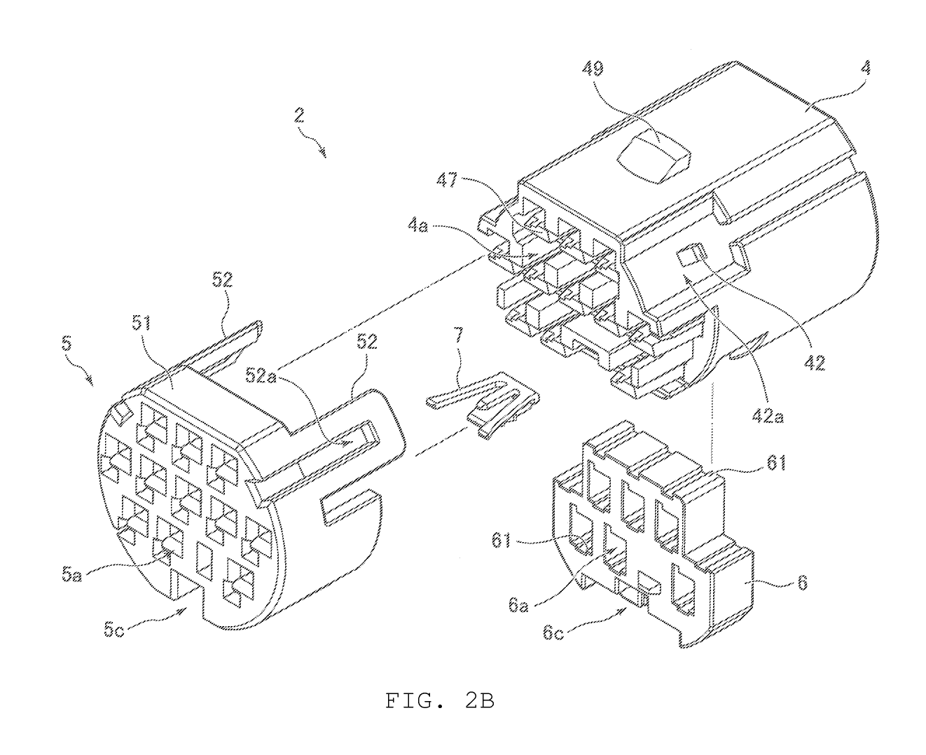

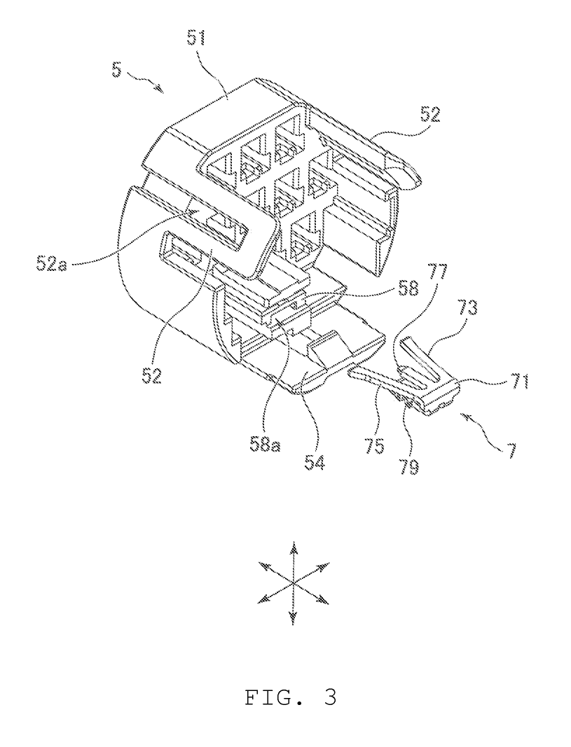

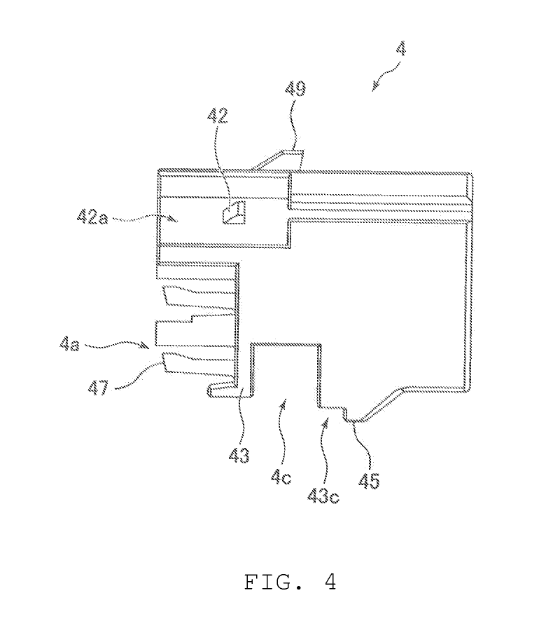

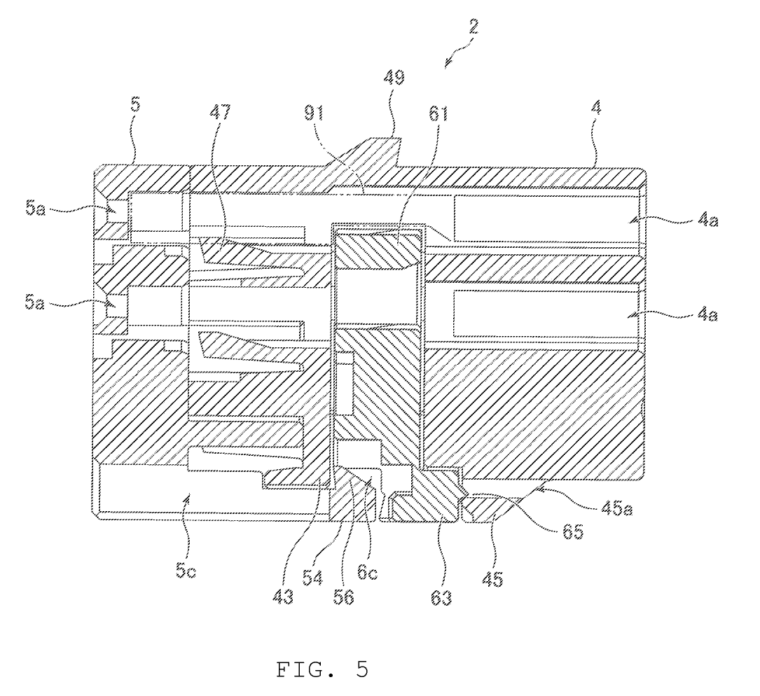

As shown in FIGS. 2A-3, the first connector 2 has a substantially columnar case 4, a cover member 5 attached to the front portion of the case 4, a holding member 6 for keeping the terminals 91 (see FIG. 5) from becoming detached, and a shunting member 7 for shunting the two terminals 91. The case 4, the cover member 5, and the holding member 6 are molded from an insulating material. The shunting member 7 is made of a conductive material.

A plurality of terminal holes 4a are formed in the case 4 which pass through the case in the longitudinal or axial direction. The terminals 91 are inserted into these terminal holes 4a from the rear (see FIG. 5). The case 4 also has an opening in the bottom portion of the side face, and a holding hole 4c is formed which extends upward from the opening. A plurality of terminal holes 4a communicates with this holding hole 4c. The holding hole 4c is formed in the central portion of the case 4 in the longitudinal direction, and the hole has a shape which becomes wider in the lateral direction.

A groove 42a is formed on both the left and right sides of the upper portion of the case 4, and both grooves extend from the front end towards the rear. An engaging piece 42 is provided on the inside of each groove 42a which protrudes towards the outside. Also, an engaging piece 47 is provided on the bottom of each terminal hole 4a which projects upwards and faces the front (see FIGS. 4-5).

The cover member 5 has a substantially disk-shaped portion 51 in which a plurality of terminal holes 5a are formed which pass through in the longitudinal direction, two engaging pieces 52 which extend from both the left and right sides of the upper portion of the disk-shaped portion 51 on the edge, and a jaw portion 54 extending to the rear from the bottom portion of the disk-shaped portion 51 on the edge. The plurality of terminal holes 5a corresponds to the plurality of terminal holes 4a formed in the case 4. More specifically, the plurality of terminal holes 5a are arranged to connect with the terminal holes 4a formed in the case 4 in the longitudinal direction when the cover member 5 is attached to the case 4.

A grove 52a extending in the longitudinal direction and closed on the rear end is formed in each engaging piece 52. These engaging pieces 52 engage the engaging pieces 42 provided on the case 4. More specifically, the engaging pieces 52 on the cover member 5 are inserted into the grooves 42a in the case 4, and the engaging pieces 42 provided in the grooves 42a are inserted into the grooves 52a formed in the engaging piece 52.

An engaging piece 56 which extends inward is provided on the tip portion of the jaw portion 54. This engaging portion 56 engages the holding hole 4c formed in the case 4 (to be described below). Also, a slit 5b is formed in the jaw portion 54 which extends to the rear from the front end. The rail portion 31 provided on the inside face of the second connector 3 is inserted into this slit 5b.

The three engaging pieces 52, 56 provided on the edge of the disk-shaped portion 51 are arranged at 120 degree intervals with reference to the center of the disk-shaped portion 51. As a result, the cover member 5 can be securely fixed to the case 4.

The cover member 5 has a support portion 58 for supporting the shunting member 7 which extends to the rear from a position near the center of the disk-shaped portion 51 on the rear face (see FIG. 3). A press-in portion 58a is formed in the support portion 58 for securing the shunting member 7.

The holding member 6 is substantially plane-shaped, and is inserted below into the holding hole 4c formed in the case 4. The holding member 6 has a plurality of engaging portions 61 on the top face and on the bottom face of the terminal holes 6a passing through in the longitudinal direction. Each engaging portion 61 corresponds to a terminal hole 4a formed in the case 4. A pressed portion 63 is provided in the bottom end portion of the holding member 6 which is projected to the rear. An engaging piece 65 projected to the rear is provided in the rear face of the pressed portion 63. Also, a recessed portion 6c is formed in the front side of the lower end portion of the holding member 6.

As shown in FIG. 5, when the holding member 6 has been inserted into the holding hole 4c in the case 4, each engaging portion 61 in the holding member 6 protrudes upward from the bottom face of each terminal hole 4a formed in the case 4, and engages a recessed portion formed in the base end portion of the terminals 91 inserted into each terminal hole 4a. This keeps the terminals 91 from coming out of the terminal holes 4a. Also, the engaging piece 47 provided in the front end portion of the case 4 engages the tip portion of the terminals 91 inserted into the terminal holes 41. This also keeps the terminals 91 from coming out of the terminal holes 4a.

The engaging piece 56 provided in the jaw portion 54 of the cover member 5 catches the edge portion 43 on the front side of the opening of the holding hole 4c receiving the inserted holding member 6. In other words, the engaging piece 56 is inserted near the opening of the holding hole 4c, and faces but does not come into contact with the rear face of the edge portion 43 on the front side. At this time, the engaging piece 56 is inserted into the recessed portion 6c formed in the bottom end portion of the holding member 6.

After the engaging piece 56 provided on the bottom portion has caught the edge portion 43 of the opening of the holding hole 4c, and the two engaging pieces 52 provided on the top portion have engaged the two engaging pieces 42 on the side faces of the case 4, the cover member 5 is attached to the front portion of the case 4. This operation can be performed in reverse order if desired.

The pressed portion 63 of the holding member 6 extends to the rear away from the jaw portion 54 of the cover member 5, and is inserted into the recessed portion 43a formed to the rear of the opening of the holding hole 4c (see FIG. 4). The engaging piece 65 provided in the rear face of the pressed portion 63 engages the engaging hole 45a formed in the protruding portion 45 to the rear of the recessed portion 43a.

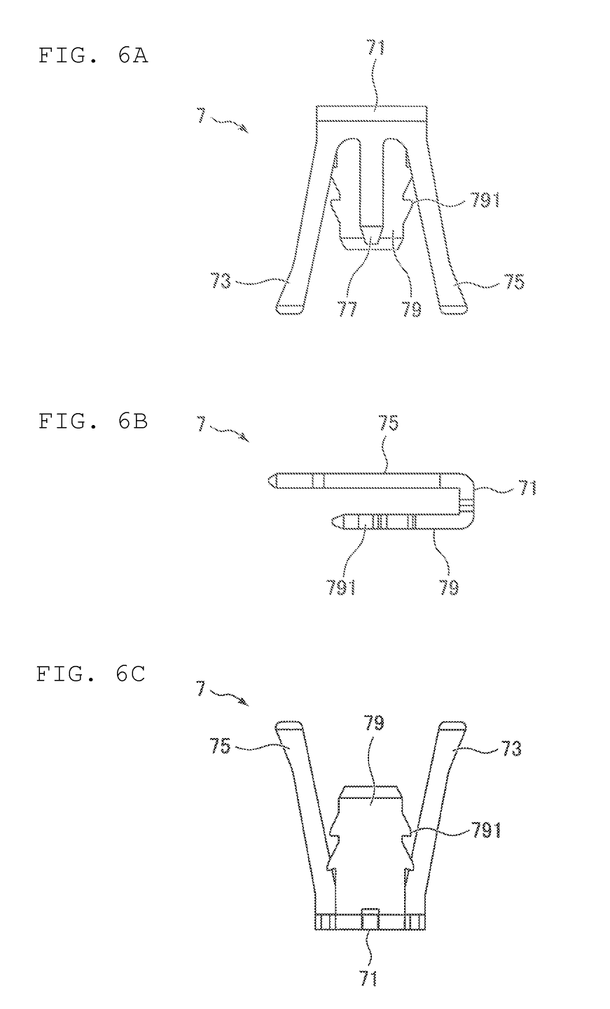

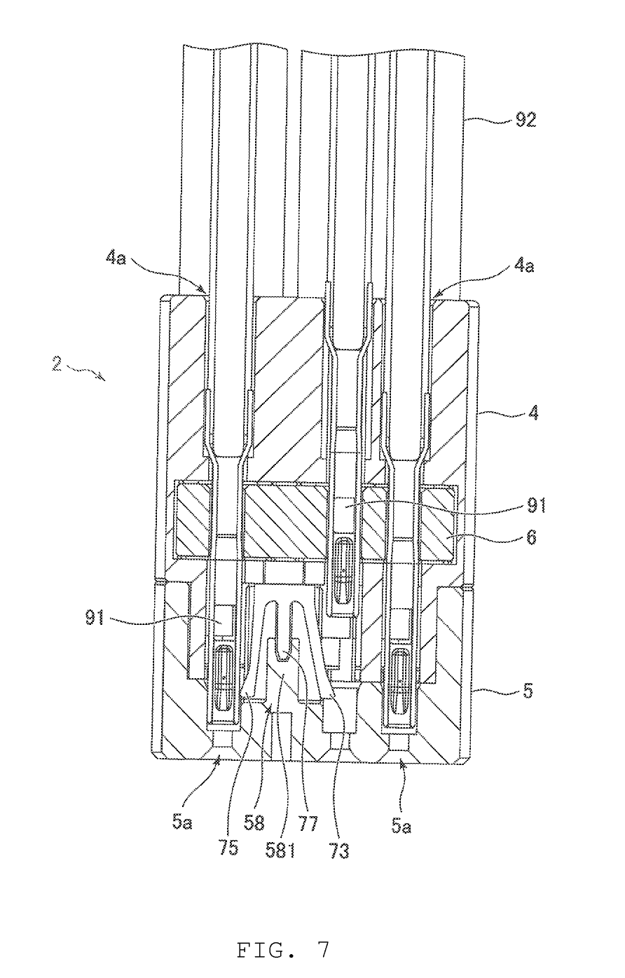

The shunting members 7 shown in FIGS. 6A-C is formed by punching and bending a metal plate. This shunting member 7 has a base end portion 71 bent into a U-shape, a first contact piece 73, second contact piece 75 and intermediate piece 77 extending to the rear from the top portion of the base end portion 71, and a fixing portion 79 extending to the rear from the bottom portion of the base end portion 71.

The inner faces of the first contact piece 73 and the second contact piece 75 move apart from each other laterally towards the rear from the base end portion 71, and are elastically deformable so as to move towards each other laterally. The intermediate piece 77 extends from the base end portion 71 between the first contact piece 73 and the second contact piece 75. The fixing portion 79 has a claw portion 791 to keep it from coming out on both sides laterally.

As shown in FIG. 7, the shunting member 7 is arranged between the case 4 and the cover member 5. The shunting member 7 is fixed to the cover member 5 by pressing the fixing portion 79 into the press-in hole 58a on the support portion 58 of the cover member 5 (see FIG. 3). When the shunting member 7 is fixed to the cover member 5, the intermediate piece 77 of the shunting member 7 engages the engaging portion 581 provided in the support portion 58 of the cover member 5.

The first contact piece 73 and the second contact piece 75 of the shunting member 7 project to the inside of the terminal holes 4a positioned on the left and right sides of the support portion 58 of the cover member 5. In other words, the first contact piece 73 and the second contact piece 75 project along the path of terminals 91 inserted into terminal holes 4a. The amount of projection of the first contact piece 73 and the second contact piece 75 increases along the path of the terminals 91 towards the front. The first contact piece 73 and the second contact piece 75 may project only from the terminal holes 5a formed in the cover member 5, or may project from both terminals holes 4a and terminal holes 5a.

The first contact piece 73 and the second contact piece 75 make contact with terminals 91 inserted into the terminal holes 4a, are elastically deformed towards the intermediate piece 77, and generate contact force with respect to the terminals 91. Because the intermediate piece 77 engages the engaging portion 581 of the cover member 5 at this time, the first contact piece 73 and the second contact piece 75 hardly affect each other when one of them comes into contact with a terminal 91 and becomes elastically deformed. Also, because the fixing portion 79 of the shunting member 7 is fitted into the cover member 5 in the same direction as the insertion direction of the terminals 91 (see FIG. 3), the shunting member 7 does not become dislocated when the first contact piece 73 and the second contact piece 75 make contact with terminals 91.

While a preferred embodiment of the Present Disclosure is shown and described, it is envisioned that those skilled in the art may devise various modifications without departing from the spirit and scope of the foregoing Description and the appended Claims.

What is claimed is:

1. A connector comprising:
a case having a plurality of terminal holes formed to insert terminals in one direction from one side;
a cover member attached to the other side of the case in the one direction and having a plurality of terminal holes formed to correspond to the plurality of terminal holes; and
a shunting member arranged between the case and the cover member, the shunting member having a first contact piece elastically deformed by contact with a terminal inserted into a first terminal hole in the case, and a second contact piece elastically deformed by contact with a terminal inserted into a second terminal hole;
wherein:
the shunting member being a metal plate, and
the first contact piece and the second piece being elastically deformed towards each other on the inside.

2. The connector of claim 1, wherein the shunting member has an intermediate piece engaging the cover member between the first contact piece and the second contact piece.

3. The connector of claim 2, wherein the shunting member has a fixing portion inserted into the cover member in the same direction as the terminal insertion direction.

4. The connector of claim 1, wherein the shunting member has a fixing portion inserted into the cover member in the same direction as the terminal insertion direction.
